(19) United States
(12) Patent Application Publication
(10) Pub. No.: US 2007/0271141 A1
(43) Pub. Date: Nov. 22, 2007

(54) Method and System for Predicting Purchases

(76) Inventor: Paul V. Storm, Dalworthington Gardens, TX (US)

Correspondence Address: STORM LLP, BANK OF AMERICA PLAZA, 901 MAIN STREET, SUITE 7100, DALLAS, TX, 75202, US

(21) Appl. No.: 11/680,715

(22) Filed: Mar. 1, 2007

Related U.S. Application Data
(60) Provisional application No. 60/777,822, filed on Mar. 1, 2006.

(51) Int. Cl. G06Q 30/00

(52) U.S. Cl. 705/14

(57) ABSTRACT

Some traditional brick-and-mortar stores, such as grocery stores, have encountered difficulties in using the online marketplace. There are a litany of reasons for this, but one reason is that the online marketplace is simply inconvenient. One purpose for the online marketplace is to make the lives of customers easier. These traditional stores can take advantage of this by utilizing purchasing data to generate lists to predict purchases for delivery, pick up, or simply as a reminder. By transmitting predicted shopping lists to consumers, more consumers would be more inclined to utilize the online and delivery services because the load on the consumers would be greatly reduced. Therefore, the predictive message service provided herein provides many benefits that have not, to this point, been available.

### CLAIM OF PRIORITY

This application claims priority from U.S. Provisional Patent Application No. 60/777,822 entitled “METHOD AND SYSTEM FOR PREDICTING PURCHASES” filed on behalf of Paul V. Storm, on Mar. 1, 2006, which is incorporated herein by reference for all purposes.

### TECHNICAL FIELD

The invention relates generally to predicting consumer behavior and, more particularly, to use algorithms to predict customer purchases based on customer purchase histories and to transmit reminder lists through electronic mail.

### BACKGROUND

Over the past ten years or so, consumers have become increasingly reliant on the Internet and other packet switching networks in their daily affairs. As a result, merchants and marketing companies have become increasingly reliant on the use of the Internet and other packet switching networks to help increase their market share and improve their footing with competitors.

Traditional “brick-and-mortar” stores are no exception to this trend; however, some markets, such as grocery stores, have traditionally had more trouble entering the electronic marketplace. Specifically, these types of merchants have not been able to effectively deliver or to allow customers to select products for delivery or pickup. These stores, though, have not ignored the electronic marketplace, but, instead, have amassed large databases in cooperation with marketing companies, like Catalina Marketing. These databases contain historical data about purchases of individual consumers and consumer groups. Accordingly, such databases provide a wealth of purchasing demographic data from which various useful information can be obtained. These databases, however, may not be utilized to their full capacity.

Therefore, there is a need for a method and/or system for effectively using data within a marketing database to assist merchants in capitalizing on what has traditionally been a difficult marketplace to enter.

### SUMMARY

A method in an electronic data processing system is provided in accordance with a preferred embodiment of the present invention. A purchase probability and a purchase frequency are calculated for at least one item of a plurality of items as a function of previous purchases associated with a customer identifier. At least one list is generated as a function of the purchase probability and the purchase frequency that includes at least one item. At least one electronic messages is transmitted to a customer associated with the customer identifier, where the list is provided in the electronic message.

In another preferred embodiment of the present invention, an inquiry in the electronic message is made to determine if any item on the list is to be prepared for pick up.

In an alternative embodiment of the present invention, the item is selected from the group consisting of a product group and a product.

In another preferred embodiment of the present invention, a plurality of electronic messages are sequentially transmitted to the customer associated with the customer identifier, wherein the period between each of the plurality of electronic messages for the customer is predetermined as a function of the purchase probability and the purchase frequency.

In an alternative embodiment of the present invention, the purchase probability is calculated by dividing the total number of item purchases by the number of purchase events, and the purchase frequency is calculated by determining the average period between sequential purchases of the items.

In another preferred embodiment of the present invention, a database is populated with a plurality of purchase entries, and each purchase entry is associated with at least one item of the plurality of items and with at least one customer identifier of a plurality of customer identifiers. Additionally, a purchase frequency is calculated for each customer identifier, and a plurality of purchase probabilities are calculated for each item, wherein each purchase probability is associated with at least one customer identifier.

In an alternative embodiment of the present invention, an inquiry is made in the electronic message to determine if any item on the list is to be delivered.

In another embodiment of the present invention, an inquiry is made in the electronic message to determine if any other items are to be delivered.

In an alternative embodiment of the present invention, a mobile station of a customer associated with the customer identifier is recognized upon entering a store, and a reminder list is transmitted to the mobile station.

In another preferred embodiment of the present invention, a system is provided. A purchase database is included having at least one entry for at least one item purchase, wherein the entry is associated with a customer identifier. A first engine to calculating a purchase probability and a purchase frequency for the item as a function of previous purchases associated with the customer identifier is also provided. A marketing database which receives the entry, the customer identifier, the purchase probability, and the purchase frequency is also included. A second engine is provided that mines the marketing database to generate at least one list as a function of the purchase probability and the purchase frequency, to transmit at least one electronic messages to a customer associated with the customer identifier, and to provide the list in the electronic message.

In an alternative embodiment of the present invention, the second engine inquires, through the electronic message, inquires if any item on the list is to be prepared for pick up.

In another preferred embodiment of the present invention, the item is selected from the group consisting of a product group and a product.

In an alternative embodiment of the present invention, the second engine sequentially transmits a plurality of electronic messages to the customer associated with the customer identifier, wherein the period between each of the plurality of electronic messages for the customer is predetermined as a function of the purchase probability and the purchase frequency.

In another preferred embodiment of the present invention, the first engine calculates the purchase probability by dividing the total number of item purchases by the number of purchase events and calculates the purchase frequency by determining the average period between sequential purchases of the item.

In an alternative embodiment of the present invention, a third engine is provided to populate the purchase database with a plurality of purchase entries and to associate each purchase entry with at least one item of the plurality of items and with at least one customer identifier of a plurality of customer identifiers.

In another preferred embodiment of the present invention, the second engine inquires, through the electronic message, if any item on the list is to be delivered.

In an alternative embodiment of the present invention, the second engine inquires, through the electronic message, if any other items are to be delivered.

In another preferred embodiment of the present invention, a fourth engine is provided to recognize a mobile station of a customer associated with the customer identifier upon entering a store and to transmit a reminder list to the mobile station.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 generally depicts a system in accordance with a preferred embodiment of the present invention.

FIGS. 2A and 2B generally depict the POP and marketing computer in accordance with a preferred embodiment of the present invention.

FIG. 3 generally depicts a flow chart for populating the purchase database in accordance with a preferred embodiment of the present invention.

FIG. 4 generally depicts data transmitted from the POP to the marketing computer in accordance with a preferred embodiment of the present invention.

FIGS. 5A and 5B generally depict a probability matrix and a frequency matrix in accordance with a preferred embodiment of the present invention.

FIG. 6 generally depicts a matrix containing mean Poisson random variables in accordance with a preferred embodiment of the present invention.

### DETAILED DESCRIPTION

In the discussion of the FIGURES, the same reference numerals will be used throughout to refer to the same or similar components.

In the following discussion, numerous specific details are set forth to provide a thorough understanding of the present invention. In other instances, well-known elements have been illustrated in schematic or block diagram form in order not to obscure the present invention in unnecessary detail. Additionally, for the most part, details concerning timing considerations and the like have been omitted inasmuch as such details are not considered necessary to obtain a complete understanding of the present invention, and are considered to be within the skills of persons of ordinary skill in the relevant art.

It is further noted that, unless indicated otherwise, all functions described herein are performed by a processor, such as a computer or electronic data processor, in accordance with code, such as computer program code and software, or integrated circuits, that are coded to perform such functions.

The term “account number” refers to a credit card number, a debit card number, or any other number associated with a financial account capable of fulfilling a purchase by electronic means.

The term “communication channel” refers to any type of electronic communication medium including, but not limited to, wireless, optical, or any other medium capable of supporting packet transmission. Additionally, a “communication channel” may be a virtual communication channel between software components within a computer system.

The term “engine” refers to any type of algorithm, module, subroutine, computer program code, software, or integrated circuits coded or configured to perform a predetermined function.

The term “mobile station” or “MS” refers to any type of wireless communication device including, but not limited to, wireless phones, Personal Digital Assistants (PDAs), computers, and so forth.

The term “base transceiver station” or “BTS” refers to a transceiver station in common usage in telecommunications. Additionally, for simplicity sake, the BTS can include any components that are necessary or desirable between a computer network and a radio frequency transmitter.

The term “computer network” refers to any computer network including, but not limited to, the Internet, a packet switching network, and so forth.

The term “electronic message” refers to any human perceptible message transmitted through an electronic communication system including, but not limited to, electronic mail (email), vocal message, text message, and so forth.

The term “item” refers to a product or category of products. For example, a product is a two liter bottle of Dr. Pepper®, and a category of products is soft drink.

The term “POP” or “Point-of-Purchase” refers to a terminal, a computer or network located at a purchase location, which includes, but is not limited to, a Personal Computer (PC), a server, a packet switching network, a Wireless Fidelity (WiFi) network or terminal, and so forth.

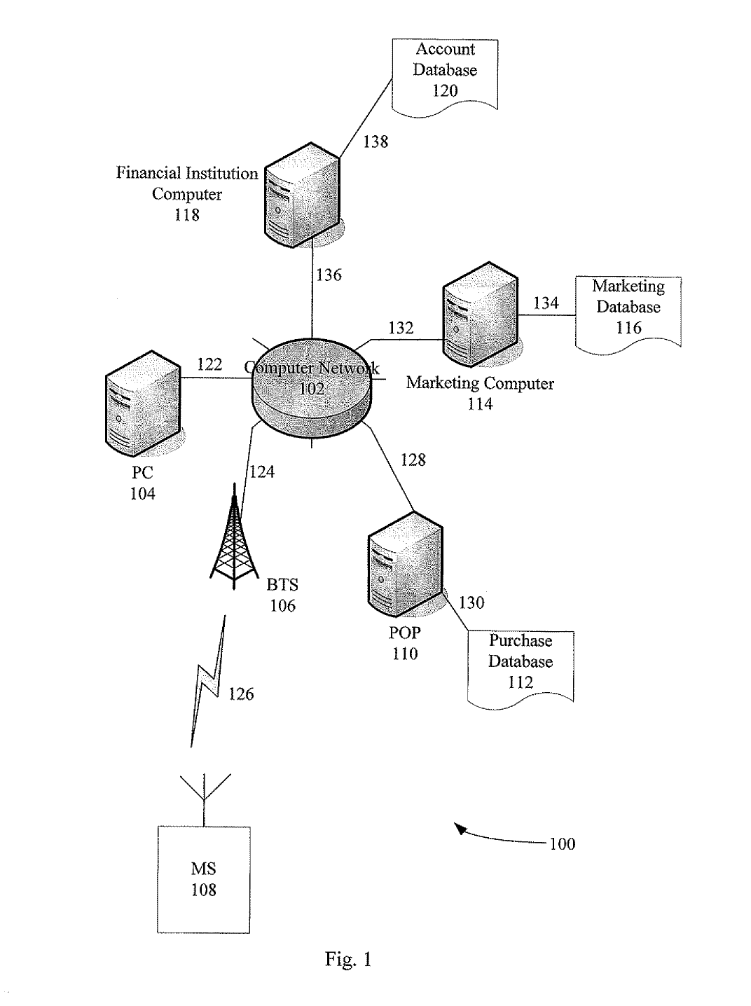

Referring to FIG. 1 of the drawings, the reference numeral 100 generally designates a system embodying features of a preferred embodiment of the present invention. The system 100 comprises a computer network 102, a Personal Computer (PC) 104, a BTS 106, an MS 108, a POP 110, a purchase database 112, a marketing computer 114, a marketing database 116, a financial institution computer 118, and an account database 120.

At the core of the system 100 is the computer network 102. The computer network 102 operates as a hub for the system 100, allowing information to be passed between different portions of the system 100. Specifically, the computer network 102 is coupled to the PC 104, the BTS 106, the POP 110, the marketing computer 114, and the financial institution computer 118 through the communication channels 122, 124, 128, 132, and 136, respectively.

However, two significant components of the system 100 are the POP 110 and marketing computer 114. The POP 110 and the marketing computer 114 operate both independently and cooperatively to develop predictive lists that can be transmitted to consumers or customers.

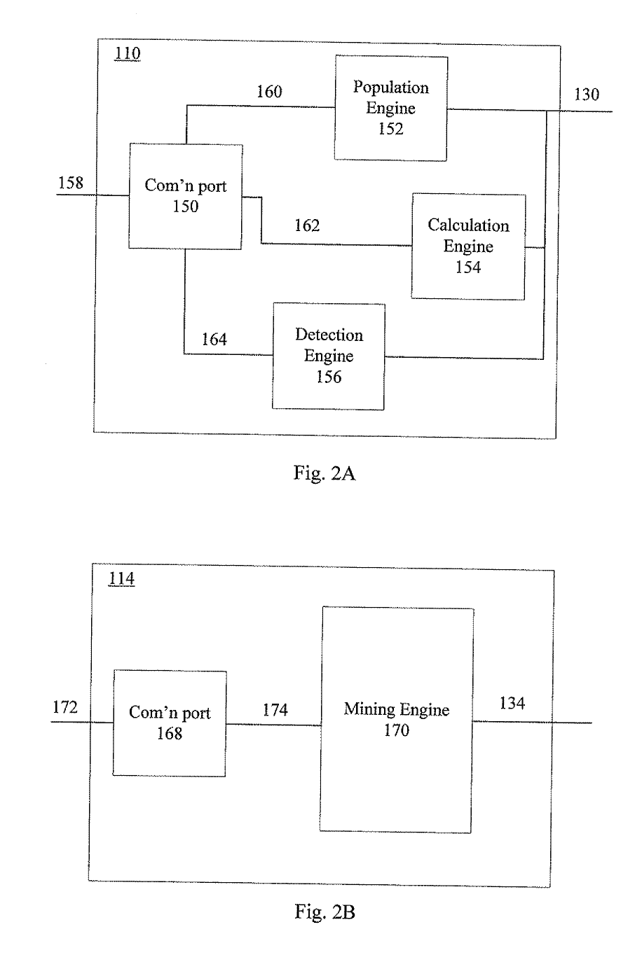

Referring to FIG. 2A of the drawings, the POP 110 is depicted in further detail. Specifically, the POP 110 includes a communication port 150, a population engine 152, a calculation engine 154, and a detection engine 156. In the POP 110, the communication port 150 is coupled to the computer network 102 through the communication channel 128 and is coupled to the population engine 152, the calculation engine 154, and the detection engine 156 through communication channels 160, 162, and 164, respectively; thus, the communication port 150 can operate as an intermediary between the computer network 102 and the engines 152, 154, and 156. Each of the engines 152, 154, and 156 can then transmit data to and receive data from the purchase database 112 through the communication channel 130.

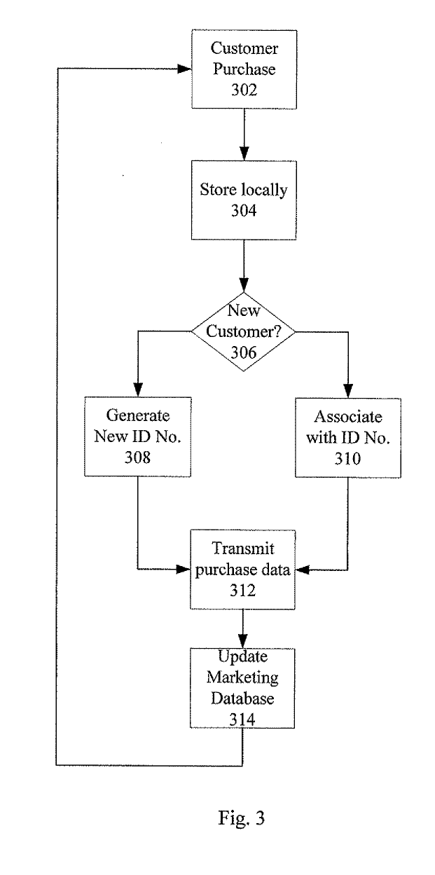

In particular, the population engine 152 records and processes information gathered as a result of consumer purchases or purchase events, thus populating the purchase database 112 with data. Referring to FIG. 3 of the drawings, the reference numeral 300 generally designates a flow chart depicting population of the purchase database.

In step 302, the consumer makes a purchase, and in step 304, the information is stored locally. Under normal circumstances, the POP 110 communicates with the purchase database 112 through communication channel 130 in order to perform the local store. Also, during the purchase, an account number is transmitted to the financial institution computer 118 through the computer network 102. The financial institution computer 118 can then update the account information stored on its account database 120 through communication channel 138 to reflect the purchase.

Once the purchase has been locally stored, a determination is made as to whether the customer is new in step 306. If the customer is new, a new identification (ID) number is generated in step 308; otherwise, an existing customer ID number is associated with the customer in step 310. The purpose of generating the ID number for the customer is for privacy reasons, such as to reduce the number of entities that have access to customer account numbers. Thus, target marketing can be performed where the only entity that possesses private information is the merchant of the POP 110.

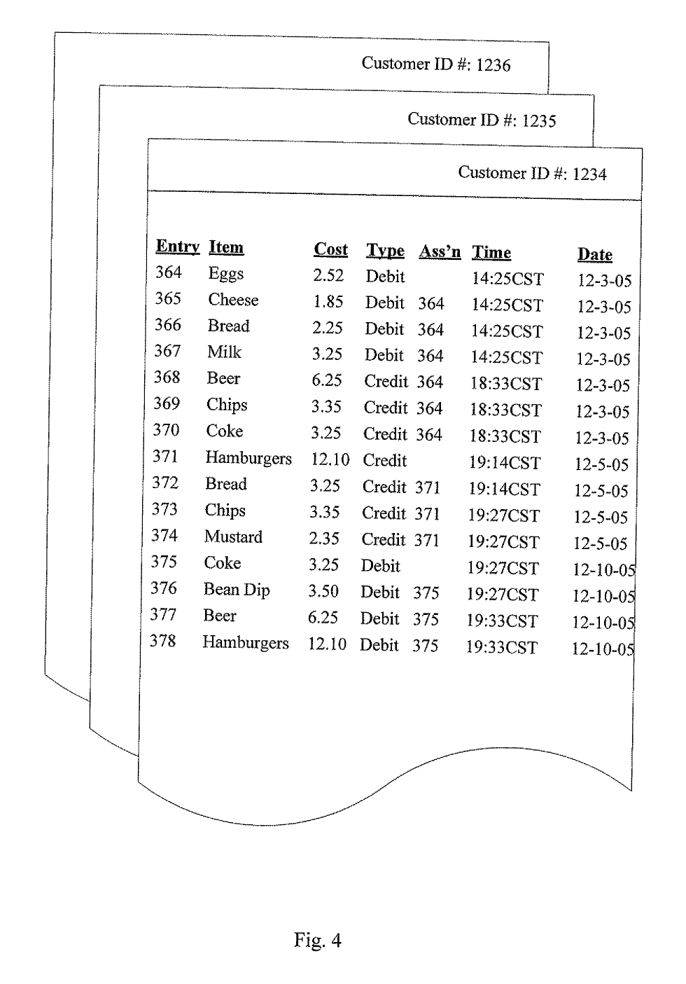

Once the privacy of the customer can be assured, purchase data is transmitted in step 312. The marketing database can then be updated in step 314. The data that is typically transmitted in step 314 can be seen in FIG. 4.

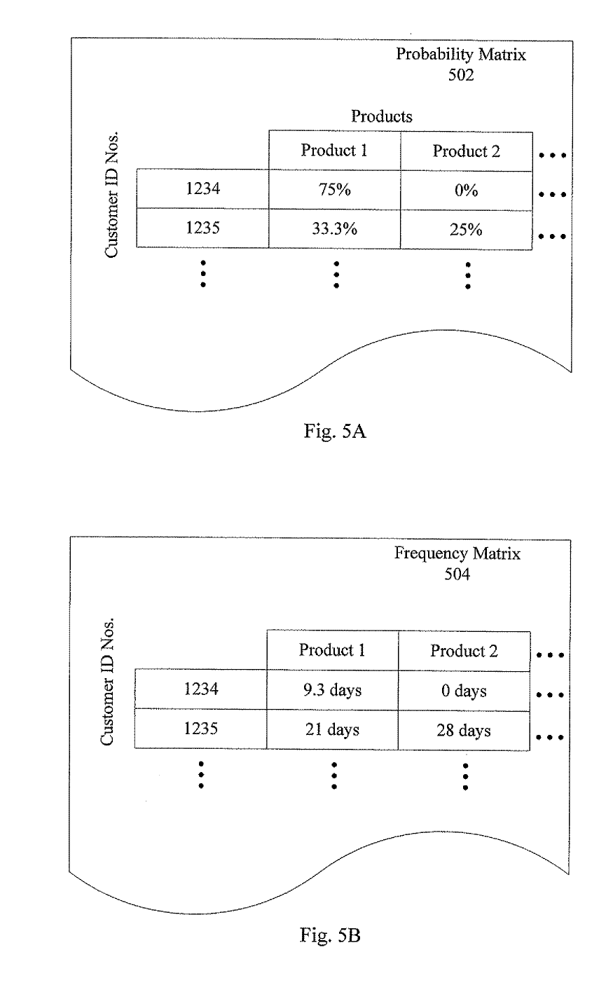

Once the purchase database is populated with consumer purchase data, the calculation engine 154 can calculate both the purchase probabilities and purchase frequencies. The purchase probabilities are the likelihood that a consumer will purchase a given item during a purchase event, and the purchase frequency is the average period between purchase events. Specifically, as can be seen in FIGS. 5A and 5B, the calculation engine 154 generates a probability matrix 502 and a frequency matrix 504. The equations for calculating the purchase frequency, denoted as F⁽ⁱ⁾, and the purchase probability, denoted as P⁽ⁱ⁾, are as follows:

P⁽ⁱ⁾=Σx⁽ⁱ⁾/m (1)

### In equation (1) above, x⁽ⁱ⁾ is a specific (i^{th}) item and m is the total number of purchases.

F⁽ⁱ⁾=(Σ t⁽ⁱ⁾)/n⁽ⁱ⁾ (2)

In equation (2) above, i is the item number, t is the time between purchases of item i, and n is the total number of purchases of item i. Examples of the purchase frequency of customer ID number 1234 are shown in FIG. 5B.

Referring to FIG. 2B of the drawings, the marketing computer 114 is shown in further detail. The marketing computer 114 comprises a communications port 168 and a mining engine 170. The communications port 168 is coupled to the computer network 102 through the communication channel 132 and is coupled to the mining engine through the communication channel 174; thus, the communications port 168 can operate as an intermediary between the computer network 102 and the mining engine 170. The mining engine 170 is also coupled to the marketing database 116 through communication channel 134.

The mining engine 170, in accordance with a preferred embodiment of the present invention, analyzes the data, specifically the purchase frequencies and the purchase probabilities, to determine when electronic messages are to be sent to customers. Such electronic messages may take the form of coupons, price notifications, lists, and so forth. Typically, there are two algorithms that can be employed: simple and Erlang distribution.

With the simple calculation, the simple algorithm provides a rapid and less accurate manner to predict purchases. The purchase probability and purchase frequency are utilized together. The average time between visits is determined by averaging the purchase frequencies for all products. The average time between visits serves as the period between electronic messages. For each visit, the items with the highest purchase probabilities are included in an electronic message to the customer.

The messages transmitted to the customer can include several pieces of information. Typically, these messages would include the predicted list of items. One of the more convenient protocols that can be used in conjunction with the electronic message is an Application Program Interface (API) so that the customer can interact with the POP 110. For example, an electronic message may ask a consumer if he or she would like to have the items delivered or prepared for pick up. Additionally, the electronic message may allow the customer to choose the item which he or she would like from the list or from the inventory of the store for either pick up or delivery.

With a more complex and accurate calculation, the mining engine 170 utilizes an Erlang distribution. The Erlang distribution allows the marketing computer to calculate the expected wait time until the purchase of a specific item. One reason for employing the Erlang distribution instead of simply relying on the purchase frequency is that there is an increased ability to predict item purchase events. The use of the Erlang distribution to predict purchases assumes that the purchases are Poisson processes with a rate of change correlated to the purchase frequency of an item. The Erlang distribution, as a probability function, is defined as follows:

(3)

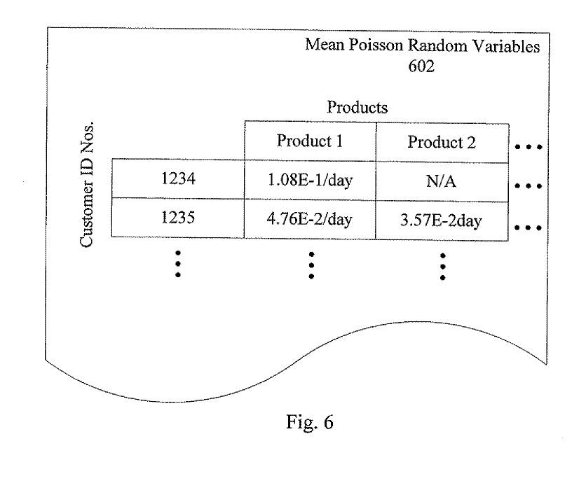

In equation (3) above, λ is the mean Poisson random variable, which is defined as the reciprocal of the purchase frequency for each item. The mining engine 170 typically calculates Mean Poisson Random Variable Matrix 602 for each customer ID number and each product, as shown in FIG. 6. Also, k denotes the number of items purchased during a single purchase event. Based on the probability function of the Erlang distribution shown above in equation (3), both the mean of the distribution and the standard deviation can be calculated, which, respectively, are as follows:

μ=k/λ(mean) (4)

σ=k^{1/2}/λ(standard deviation) (5)

An example of simple calculations using the Erlang distribution is as follows. If one desires to determine when customer ID number 1234 will next buy Product 1 using the Mean Poisson Random Variable Matrix 602, k=1 and λ=1.08*10⁻¹/day. Therefore, the mean and standard deviation are as follows:

μ≈9.3 days (6)

σ≈9.3 days (7)

[symbol] P(x)=−

As an example of a more complex calculation, many items are purchased in pairs or other multiples, such as batteries. In this instance, the Erlang distribution allows for prediction of when 3 packages of batteries will be purchased at the same time. If Customer ID number 1234 purchases batteries periodically (λ_{batteries}=1.08*10⁻²/day) and a store seeks to send an electronic message when three packages are predicted to be bought, the average time and standard deviation for this predicted purchase event would be as follows:

μ=3/(1.08*10⁻²) days≈279 days (8)

σ=(3)^{1/2}/(1.08*10⁻²) days≈161 days (9)

In addition to predicting the purchase rates for specific items, the mining engine 170 is able to generate and transmit electronic messages to the consumer. Because certain privacy issues exist, the mining engine 170 will generally utilize a blind protocol to send the electronic message to the consumer. In other words, an electronic message intended for a specific consumer is transmitted from the marketing computer 114 to the POP 110. The POP 110 can retransmit the electronic message through any number of communication protocols, such as email, text messaging, or a voice communication. Specifically, these electronic messages can be transmitted to the PC 104, or to an MS 108 through the BTS 106 and communication channel 126.

Moreover, in accordance with the present invention, the mining engine 134 is able to discern the day of the week that a customer is likely to go to a store. Based on database entries received, the mining engine 134 can calculate a day-of-the-week probability, which is the percentage of purchases made during each day of the week. Thus, the electronic message can be sent prior to the days when a customer is most likely to make purchases and can predict the items to be purchased.

With the Erlang distribution, the messages transmitted to the customer can also include several pieces of information. Typically, these messages would include the predicted list of items, such as a proposed shopping list. For example, using API techniques, an electronic message may ask a consumer if he or she would like to have the items delivered or prepared for pick up. Additionally, the electronic message may allow the customer to choose the item which he or she would like from the list or from the inventory of the store for either pick up or delivery.

One other feature available for use would be a reminder list, which is provided through a customer's MS 108. Based on previous purchase events, rapidly produced lists could be sent to a customer upon entering a store. In order to perform this function, the detection engine 156 would detect a customer's MS 108 upon entering the store. A list would then be generated and transmitted to the MS 108. Thus, the customer may be reminded of items that he or she would normally purchase.

Additionally, many times transactions may be conducted without accounts, i.e. with cash. Thus, at checkout a detector (not shown) could detect the presence of an MS 108 and associate a purchase with the MS 108. The number associated with the MS 108 could, instead, be used to track purchases. The marketing computer 114 could then send text messages to the MS 108 reminding the person of future purchases upon acceptance of a request for this service. Therefore, the system 100 could automatically track purchases without burdening the consumer for requests for information.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A method in an electronic data processing system, comprising:
calculating a purchase probability and a purchase frequency for at least one item of a plurality of items as a function of previous purchases associated with a customer identifier;
generating at least one list as a function of said purchase probability and said purchase frequency that includes at least one item;
transmitting at least one electronic message to a customer associated with said customer identifier; and
providing said list in said electronic message.

2. The method of claim 1, wherein the method further comprises inquiring in said electronic message if any item on said list is to be prepared for pick up.

3. The method of claim 1, wherein said item is selected from the group consisting of a product group and a product.

4. The method of claim 1, wherein the step of transmitting further comprises sequentially transmitting a plurality of electronic messages to said customer associated with said customer identifier, wherein the period between each of said plurality of electronic messages for said customer is predetermined as a function of said purchase probability and said purchase frequency.

5. The method of claim 4, wherein the step of calculating further comprises:
calculating said purchase probability by dividing the total number of item purchases by the number of purchase events; and
calculating said purchase frequency by determining the average period between sequential purchases of said item.

6. The method of claim 1, wherein the step of calculating further comprises:
populating a database with a plurality of purchase entries;
associating each purchase entry with at least one item of said plurality of items and with at least one customer identifier of a plurality of customer identifiers;
calculating a purchase frequency for each customer identifier; and
calculating a plurality of purchase probabilities for each item, wherein each purchase probability is associated with at least one customer identifier.

7. The method of claim 1, wherein the method further comprises inquiring in said electronic message if any item on said list is to be delivered.

8. The method of claim 7, wherein the step of inquiring further comprises inquiring in said electronic message if any other items are to be delivered.

9. The method of claim 1, wherein the method further comprises:
recognizing a mobile station of a customer associated with said customer identifier upon entering a store; and
transmitting a reminder list to said mobile station.

10. A computer program, comprising:
computer code for calculating a purchase probability and a purchase frequency for at least one item of a plurality of items as a function of previous purchases associated with a customer identifier;
computer code for generating at least one list as a function of said purchase probability and said purchase frequency that includes at least one item;
computer code for transmitting at least one electronic message to a customer associated with said customer identifier; and
computer code for providing said list in said electronic message.

11. The method of claim 10, wherein the computer program further comprises computer code for inquiring in said electronic message if any item on said list is to be prepared for pick up.

12. The computer program of claim 10, wherein said item is selected from the group consisting of a product group and a product.

13. The computer program of claim 10, wherein the computer code for transmitting further comprises computer code for sequentially transmitting a plurality of electronic messages to said customer associated with said customer identifier, wherein the period between each of said plurality of electronic messages for said customer is predetermined as a function of said purchase probability and said purchase frequency.

14. The computer program of claim 13, wherein the computer code for calculating further comprises:
computer code for calculating said purchase probability by dividing the total number of item purchases by the number of purchase events; and
computer code for calculating said purchase frequency by determining the average period between sequential purchases of said item.

15. The computer program of claim 10, wherein the computer code for calculating further comprises:
computer code for populating a database with a plurality of purchase entries;
computer code for associating each purchase entry with at least one item of said plurality of items and with at least one customer identifier of a plurality of customer identifiers;
computer code for calculating a purchase frequency for each customer identifier; and
computer code for calculating a plurality of purchase probabilities for each item, wherein each purchase probability is associated with at least one customer identifier.

16. The computer program of claim 10, wherein the computer program further comprises computer code for inquiring in said electronic message if any item on said list is to be delivered.

17. The computer program of claim 16, wherein the computer code for inquiring further comprises computer code for inquiring in said electronic message if any other items are to be delivered.

18. The computer program of claim 10, wherein the computer program further comprises:
computer code for recognizing a mobile station of a customer associated with said customer identifier upon entering a store; and
computer code for transmitting a reminder list to said mobile station.

19. A system comprising:
a purchase database having at least one entry for at least one item purchase, wherein said entry is associated with a customer identifier;
a first engine for calculating a purchase probability and a purchase frequency for said item as a function of previous purchases associated with said customer identifier;
a marketing database that receives said entry, said customer identifier, said purchase probability, and said purchase frequency; and
a second engine that mines said marketing engine to:
generate at least one list as a function of said purchase probability and said purchase frequency;
transmit at least one electronic messages to a customer associated with said customer identifier; and
provide said list in said electronic message.

20. The system of claim 19, wherein said second engine inquires, through said electronic message, if any item on said list is to be prepared for pick up.

21. The system of claim 19, wherein said item is selected from the group consisting of a product group and a product.

22. The system of claim 19, wherein said second engine sequentially transmits a plurality of electronic messages to said customer associated with said customer identifier, wherein the period between each of said plurality of electronic messages for said customer is predetermined as a function of said purchase probability and said purchase frequency.

23. The system of claim 22, wherein said first engine:
calculates said purchase probability by dividing the total number of item purchases by the number of purchase events; and
calculates said purchase frequency by determining the average period between sequential purchases of said item.

24. The system of claim 19, wherein the system further comprises:
a third engine to:
populate said purchase database with a plurality of purchase entries; and
associate each purchase entry with at least one item of said plurality of items and with at least one customer identifier of a plurality of customer identifiers.

25. The system of claim 19, wherein said second engine inquires, through said electronic message, if any item on said list is to be delivered.

26. The method of claim 25, wherein said second engine inquires through said electronic message if any other items are to be delivered.

27. The system of claim 19, wherein the system further comprises:
a fourth engine to:
recognize a mobile station of a customer associated with said customer identifier upon entering a store; and
transmit a reminder list to said mobile station.
